(19) United States
(12) Patent Application Publication
(10) Pub. No.: US 2009/0204671 A1
(43) Pub. Date: Aug. 13, 2009

(54) IN-MEETING PRESENCE

(75) Inventors: Quinn Hawkins, Kirkland, WA (US); Kapil Sharma, Woodinville, WA (US); Avronil Bhattacharjee, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/028,011

(22) Filed: Feb. 8, 2008

(51) Int. Cl. G06F 15/16

(52) U.S. Cl. 709/204

(57) ABSTRACT

Architecture that presents general presence information and in-meeting presence information as advanced state presence information in the roster of a virtual conference meeting or session. For example, one advanced state is showing a user that was invited to the session but that has not joined into the session. The advanced state presence information can also then show what the user is currently doing (e.g., offline, busy, etc.). Moreover, the advanced state presence information can show the communications state (e.g., audio) of the user such as free/busy information, call information, desktop locked (to attend to other activities), and so on.

### BACKGROUND

A new generation of applications exposes presence information of a user for a given context. The presence information allows other users to know, to some extent, the current “state” of that individual. Thus far, this state has been limited to broad activity categories such as free, busy, away, etc. New versions of presence application are including additional information such as physical location of the user (e.g., home, office).

Web conferencing programs can maintain a roster of participants in a meeting and that show a complete separate and different presence such as in-meeting roll, audio and video status, some or all of the content currently being viewed or perceived in the meeting, and the quality of a participant connection. The in-meeting roster presence contains information for fellow meeting participants, but the in-meeting roster presence is limited only to in-meeting events. The in-meeting roster presence technology fails to communicate when external events have changed fellow participant meeting state such as a phone call or a required break, which can impact a participant's ability to effectively participate in the meeting.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture is a hybrid presence solution that combines user presence from the broader presence system that is aware of high-level states (e.g., physical location, free/busy/in-a-call) with the more granular presence of the current state of the user in a meeting. This provides the meeting participants with more information to significantly improve the meeting experience.

To the accomplishment of the foregoing and related ends, certain illustrative aspects are described herein in connection with the following description and the annexed drawings. These aspects are indicative, however, of but a few of the various ways in which the principles disclosed herein can be employed and is intended to include all such aspects and equivalents. Other advantages and novel features will become apparent from the following detailed description when considered in conjunction with the drawings.

### BRIEF DESCRIPTION OF THE DRAWINGS

FIG. 1 illustrates a computer-implemented presence system that presents advanced state presence information as part of a roster.

FIG. 2 illustrates a system that facilitates advanced state presence information for a web conferencing application.

FIG. 3 illustrates an exemplary in-meeting roster for presenting advanced state presence information.

FIG. 4 illustrates a computer-implemented method of processing presence information.

FIG. 5 illustrates an alternative method of providing advanced state presence information to a client for presentation in a session roster.

FIG. 6 illustrates a block diagram of a computing system operable to execute advanced presence information processing in accordance with the disclosed architecture.

FIG. 7 illustrates a schematic block diagram of an exemplary computing environment for advanced state presence information processing.

### DETAILED DESCRIPTION

The disclosed architecture presents general presence information and in-meeting presence information as advanced state presence information in the roster of a virtual conference meeting or session. For example, one advanced state shows a user that was invited to the session but that has not joined into the session. The advanced state presence information can also then show what the user is currently doing (e.g., offline, busy, etc.). Moreover, the advanced state presence information can show the communications state (e.g., audio) of the user such as free/busy information, call information, desktop locked (to attend to other activities), and so on.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof.

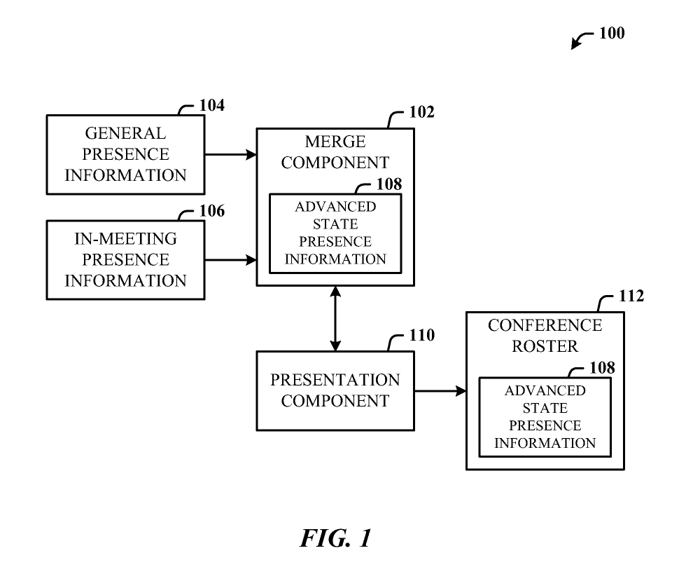

FIG. 1 illustrates a computer-implemented presence system 100 that presents advanced state presence information as part of a roster. The system 100 includes a merge component 102 for receiving and merging general presence information 104 and in-meeting presence information 106 of a conferencing session into advanced state presence information 108. A presentation component 110 of the system 100 presents the advanced state presence information 108 as part of a conference roster 112 of the conferencing session.

The general presence information 104 is that which is normally associated with conventional presence systems. The in-meeting presence information 106 pertains only to the session (e.g., web conference). Thus, the conference roster 112 now presents the broader general state information and the more granular in-meeting presence information.

Consider the following scenario that exemplifies the novel advanced state presence information. User A is in a web conferencing meeting with a coworker User B. User B is listening to User A when User B receives and takes an important call. User A finishes talking and wants to ask User B a question. Fortunately, User A can see User B is in a call and knows that User A will need to continue with the meeting and follow up with User B after User B completes the call. This illustrates how although User B remains “in the meeting”, User B is not always available.

This problem is easily avoided in a physical meeting because participants can easily see when another participant takes a call. However, this is a problem in virtual meetings.

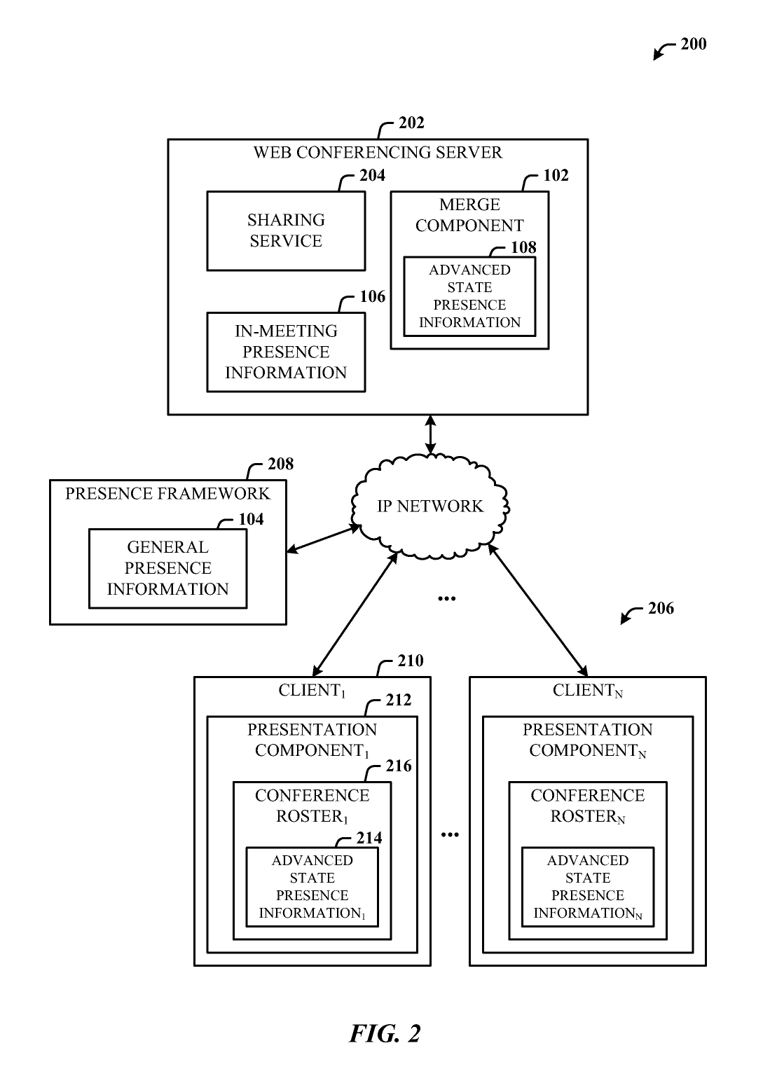

FIG. 2 illustrates a system 200 that facilitates advanced state presence information for a web conferencing application. The system 200 shows a web conferencing server 202 that runs a sharing service 204 (e.g., collaboration, conferencing) for the benefit of multiple clients 206. The sharing service 204 facilitates a conferencing session where the clients 206 connect in for multi-party interaction. A presence framework 208 provides the general presence information 104 (e.g., busy, away, free for chat, do not disturb, out to lunch, etc.) that conveys the ability and willingness of a communication user to enter into communication.

The presence framework 208 can include a presence server (for managing presence information on behalf of a presence entity), watcher applications (for obtaining SIP (session initiation protocol) and non-SIP (e.g., SMS-short message service, WAP-wireless application protocol, WV-wireless village)) presence information), watcher presence proxies, presence entity presence proxies, and so on, further information about which can be found in the 3GPP TS 23.141 specification on presence services.

The clients 206 publish general presence state to the presence framework 208 where the general presence state is formed as the general presence information 104 and sent to the web conferencing server 202. The conferencing server 202 includes functionality that generates the in-meeting presence information 106 that tracks session participant actions. The merge component 102 merges or combines the general presence information 104 and the in-meeting presence information 106 for presentation as the advanced state presence information 108. The in-meeting presence information 106 can be obtained based on user interaction with the sharing service 204 such as part of a session.

The conferencing server 202 sends the advanced state presence information 108 to the clients 206 for presentation in the client conference rosters. For example, a first client 210 includes a first presentation component 212 for presenting advanced state presence information 214 in a first client conference roster 216. The advanced state presence information 214 can be different than the advanced state presence information 108 compiled at the conferencing server 202, since the presence information 214 of the first client 210 does not need to show the presence state of the first client 210. Thus, the first client 210 can modify the received advanced state presence information 108 to generate and present the advanced state presence information 214. However, this is not to be construed as a limitation, in that in an alternative implementation, the client presentation component 216 shows the advanced state presence information 108 at the first client 210 such that the user at the first client 210 can see the first client state. The above operations apply the same for the other clients, as well.

In other words, when a user joins the session, the presentation component 212 of the first client 210 (e.g., a session or conferencing client) queries the presence framework 208 for general presence information. The first client 210 receives and sends the general presence information to the conferencing server 202. The conferencing server merges the general presence information and the in-meeting presence information into the advanced state presence information 108, and sends the advanced state presence information 108 to the first client 210 for presentation by the presentation component in the conference roster 216. Updates are then performed periodically and/or dynamically as presence state and in-meeting state change.

The advanced state presence information 108 includes and the presentation component 212 presents information where a user is invited but not attending the session. The conferencing server 202 creates and supports a web-based audio and/or video conferencing session. Additionally, the session can be a collaborative sharing session that supports video and audio interaction. The advanced state presence information 108 can include virtual location information of a user and the advanced state presence information 214 of the first client 210 is selectable (e.g., an active link) for accessing the virtual location. The virtual location can be associated with a messaging client, a SIP client, a voice call, and/or a video conferencing client, for example. Moreover, the advanced state presence information 108 (and/or 214) is automatically updated based on changes to the general presence information and/or in-meeting presence information.

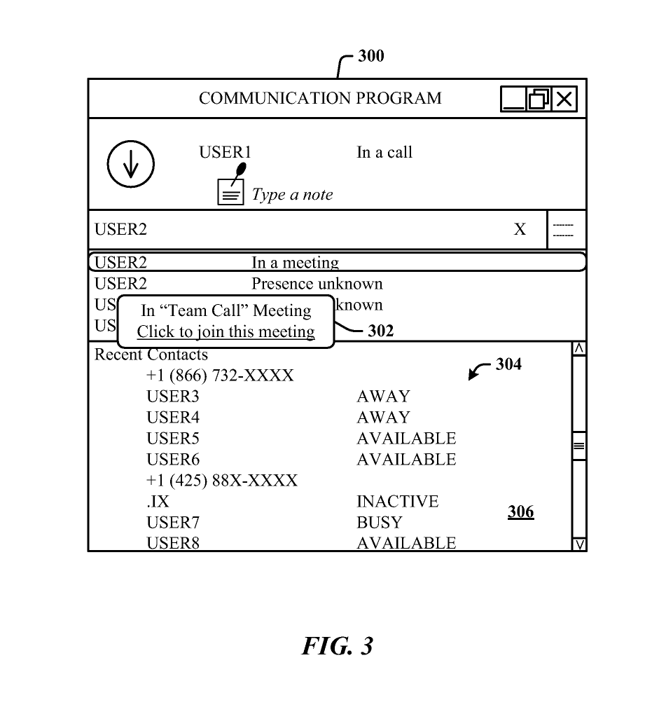

FIG. 3 illustrates an exemplary in-meeting roster 300 for presenting advanced state presence information. Current presence systems do not provide a user with sufficient information to join the meeting, for example, by only presenting “in a meeting”. Since an increasing number of meetings are now virtual (e.g., web conferencing, collaboration, etc.), the location cannot be automatically sensed and provided. As illustrated, the disclosed architecture provides more specific presence information in the session roster 300. For example, the state for USER1 is shown as “in a call”. The roster 300 also allows USER1 to find the advanced state of other users such as a USER2, which state is shown as “in a meeting”. More detailed state information is also presented in a popup box 302 indicating that USER2, as selected, is specifically in a meeting called Team Call. Additionally, USER1 can also select to join the Team Call meeting via a link (underlined text) in the popup box 302. The general presence information 304 for other users is provided below in a Recent Contacts pane 306.

Following is a series of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

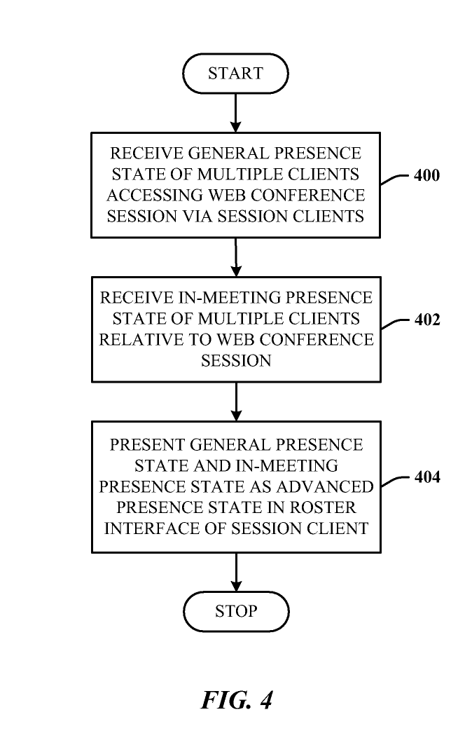

FIG. 4 illustrates a computer-implemented method of processing presence information. At 400, general presence state of multiple clients accessing a web conference session via a session client is received. At 402, in-meeting presence state of the multiple clients relative to the web conference session is received. At 404, the general presence state and the in-meeting presence state are presented as advanced presence state in a roster interface of the session client.

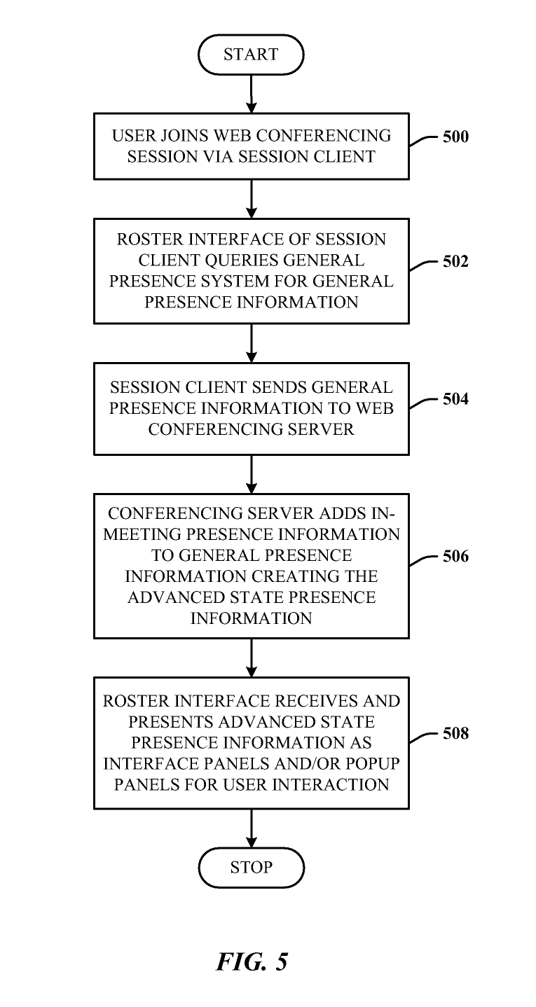

FIG. 5 illustrates an alternative method of providing advanced state presence information to a client for presentation in a session roster. At 500, a user joins a web conferencing session using a session client. At 502, a roster interface of the session client queries a general (e.g., external) presence system for general presence information. At 504, the session client sends the session general presence information to the web conferencing server. At 506, the conferencing server adds in-meeting presence information to the general presence information to create the advanced state presence information. At 508, the roster interface of the session client receives the advanced state presence information and presents the information as interface panels and/or popup panels for user interaction.

The conferencing session is a web-based collaborative sharing session that supports video and audio interaction. The advanced presence information can be presented and interacted with via a SIP client and a messaging client, for example. A client can be joined to the conferencing session based on interaction with the advanced presence information. The general presence information and the in-meeting presence information are presented via the roster interfaces.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

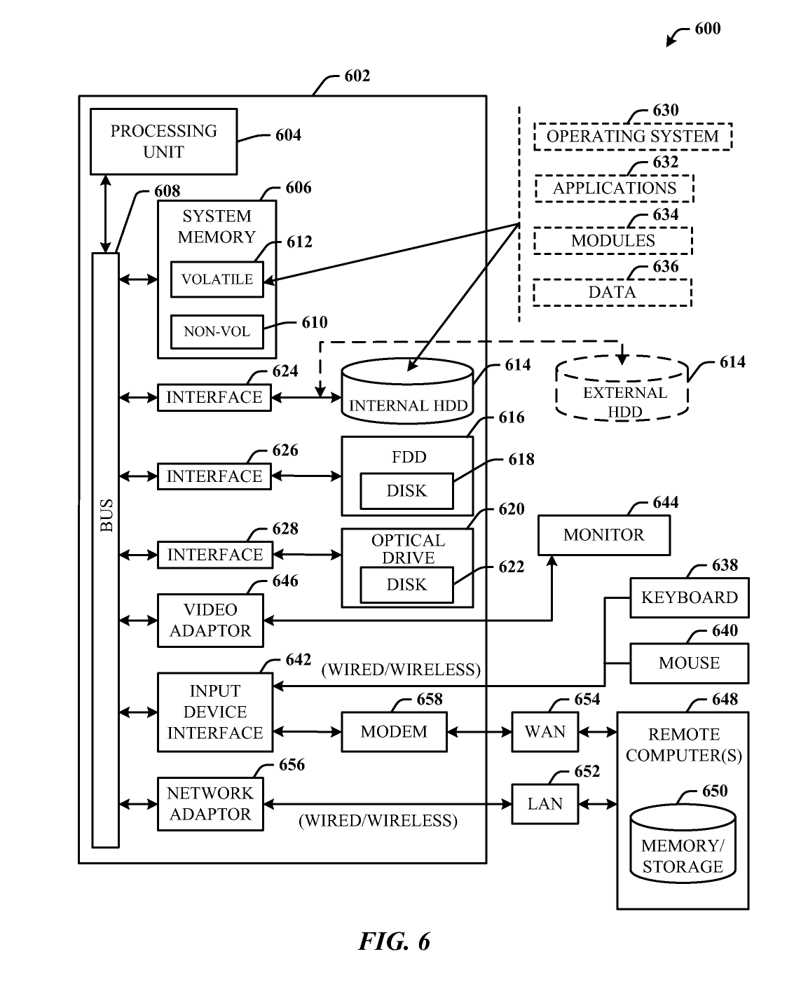

Referring now to FIG. 6, there is illustrated a block diagram of a computing system 600 operable to execute advanced presence information processing in accordance with the disclosed architecture. In order to provide additional context for various aspects thereof, FIG. 6 and the following discussion are intended to provide a brief, general description of a suitable computing system 600 in which the various aspects can be implemented. While the description above is in the general context of computer-executable instructions that may run on one or more computers, those skilled in the art will recognize that a novel embodiment also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 6, the exemplary computing system 600 for implementing various aspects includes a computer 602 having a processing unit 604, a system memory 606 and a system bus 608. The system bus 608 provides an interface for system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 can include non-volatile memory (NON-VOL) 610 and/or volatile memory 612 (e.g., random access memory (RAM)). A basic input/output system (BIOS) can be stored in the non-volatile memory 610 (e.g., ROM, EPROM, EEPROM, etc.), which BIOS are the basic routines that help to transfer information between elements within the computer 602, such as during start-up. The volatile memory 612 can also include a high-speed RAM such as static RAM for caching data.

The computer 602 further includes an internal hard disk drive (HDD) 614 (e.g., EIDE, SATA), which internal HDD 614 may also be configured for external use in a suitable chassis, a magnetic floppy disk drive (FDD) 616, (e.g., to read from or write to a removable diskette 618) and an optical disk drive 620, (e.g., reading a CD-ROM disk 622 or, to read from or write to other high capacity optical media such as a DVD). The HDD 614, FDD 616 and optical disk drive 620 can be connected to the system bus 608 by a HDD interface 624, an FDD interface 626 and an optical drive interface 628, respectively. The HDD interface 624 for external drive implementations can include at least one or both of Universal Serial Bus (USB) and IEEE 1394 interface technologies.

The drives and associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette (e.g., FDD), and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 612, including an operating system 630, one or more application programs 632, other program modules 634, and program data 636. The one or more application programs 632, other program modules 634, and program data 636 can include the clients 206, the presentation component 212, conference roster 216, and advanced state presence information 214, for example.

All or portions of the operating system, applications, modules, and/or data can also be cached in the volatile memory 612. It is to be appreciated that the disclosed architecture can be implemented with various commercially available operating systems or combinations of operating systems.

A user can enter commands and information into the computer 602 through one or more wire/wireless input devices, for example, a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces such as a parallel port, IEEE 1394 serial port, a game port, a USB port, an IR interface, etc.

A monitor 644 or other type of display device is also connected to the system bus 608 via an interface, such as a video adaptor 646. In addition to the monitor 644, a computer typically includes other peripheral output devices (not shown), such as speakers, printers, etc.

The computer 602 may operate in a networked environment using logical connections via wire and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wire/wireless connectivity to a local area network (LAN) 652 and/or larger networks, for example, a wide area network (WAN) 654. Such LAN and WAN networking environments are commonplace in offices and companies, and facilitate enterprise-wide computer networks, such as intranets, all of which may connect to a global communications network, for example, the Internet.

When used in a LAN networking environment, the computer 602 is connected to the LAN 652 through a wire and/or wireless communication network interface or adaptor 656. The adaptor 656 can facilitate wire and/or wireless communications to the LAN 652, which may also include a wireless access point disposed thereon for communicating with the wireless functionality of the adaptor 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wire and/or wireless device, is connected to the system bus 608 via the input device interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

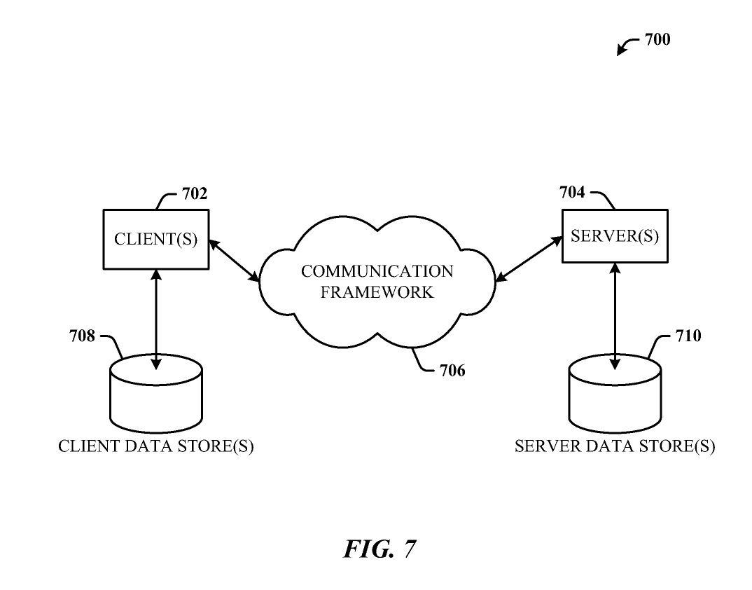

Referring now to FIG. 7, there is illustrated a schematic block diagram of an exemplary computing environment 700 for advanced state presence information processing. The environment 700 includes one or more client(s) 702. The client(s) 702 can be hardware and/or software (e.g., threads, processes, computing devices). The client(s) 702 can house cookie(s) and/or associated contextual information, for example.

The environment 700 also includes one or more server(s) 704. The server(s) 704 can also be hardware and/or software (e.g., threads, processes, computing devices). The servers 704 can house threads to perform transformations by employing the architecture, for example. One possible communication between a client 702 and a server 704 can be in the form of a data packet adapted to be transmitted between two or more computer processes. The data packet may include a cookie and/or associated contextual information, for example. The environment 700 includes a communication framework 706 (e.g., a global communication network such as the Internet) that can be employed to facilitate communications between the client(s) 702 and the server(s) 704.

Communications can be facilitated via a wire (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

The client(s) 702 can include the clients 206, and the server(s) 706 can include the web conferencing server 202.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented presence system, comprising:
a merge component for receiving and merging general presence information and in-meeting presence information of a conferencing session into advanced state presence information; and
a presentation component for presenting the advanced state presence information as part of a roster of the conferencing session.

2. The system of claim 1, wherein the advanced state presence information includes and the presentation component presents information where a user is invited but not attending the session.

3. The system of claim 1, wherein the conferencing session is a web-based audio conferencing session.

4. The system of claim 1, wherein the conferencing session is a web-based video conferencing session.

5. The system of claim 1, wherein the conferencing session is a web-based collaborative sharing session that supports video and audio interaction.

6. The system of claim 1, wherein the advanced state presence information includes virtual location information of a user.

7. The system of claim 6, wherein the advanced state presence information is selectable for accessing the virtual location.

8. The system of claim 7, wherein the virtual location is associated with a messaging client, a SIP client, a voice call client, or a video conferencing client.

9. The system of claim 1, wherein the advanced state presence information is automatically updated based on changes to the general presence information or in-meeting presence information.

10. A computer-implemented method of processing presence information, comprising:
receiving general presence state of multiple clients accessing a web conference session via a session client;
receiving in-meeting presence state of the multiple clients relative to the web conference session; and
presenting the general presence state and the in-meeting presence state as advanced presence state in a roster interface of the session client.

11. The method of claim 10, further comprising presenting the advanced presence state in a popup box.

12. The method of claim 10, further comprising exposing the advanced presence state as a selectable link.

13. The method of claim 10, further comprising updating the advanced presence state based on changes to the in-meeting presence state or the general presence state.

14. The method of claim 10, wherein the web conference session is a video conferencing session with audio communications.

15. A computer-implemented method of processing presence information, comprising:
receiving general presence information of a presence system from client roster interfaces of multiple clients interacting with a web conferencing session;
adding in-meeting presence state information of the web conferencing session to the general presence information to create advanced presence information; and
sending the advanced presence information to the client rosters for presentation and user interaction.

16. The method of claim 15, wherein the advanced presence information is presented and interacted with via a SIP client.

17. The method of claim 15, wherein the advanced presence information is presented and interacted with via a messaging client.

18. The method of claim 15, further comprising joining a client to the conferencing session based on interaction with the advanced presence information.

19. The method of claim 15, further comprising presenting the general presence information and the in-meeting presence information via the roster interfaces.

20. The method of claim 15, wherein the conferencing session is a web-based collaborative sharing session that supports video and audio interaction.
